(19) United States
(12) Patent Application Publication
(10) Pub. No.: US 2015/0091860 A1
(43) Pub. Date: Apr. 2, 2015

(54) METHOD FOR PREVENTING FALSE ACTIVATION OF TOUCH PAD

(71) Applicant: TIANJIN FUNAYUANCHUANG TECHNOLOGY CO.,LTD., Tianjin (CN)

(72) Inventors: PO-SHENG SHIH, New Taipei (TW); CHIEN-YUNG CHENG, New Taipei (TW); LI-MIN CHAO, New Taipei (TW)

(21) Appl. No.: 14/499,463

(22) Filed: Sep. 29, 2014

(30) Foreign Application Priority Data
Sep. 27, 2013 (CN) 201310447335.3

(51) Int. Cl. G06F 3/041

(52) U.S. Cl. CPC G06F 3/0418
USPC 345/174

(57) ABSTRACT

A method for preventing a false activation of a touch pad is provided. In the method, a touch area of the touch pad is divided into subareas. A lock threshold N_{lock} and a sensing signal threshold V_{lock} are set. The touch pad is scanned when there is a touch acted on the touch pad. A quantity Nᵢ of touch points in each of the subareas is counted. If the quantity Nᵢ of the touch points in a certain subarea is less than N_{lock}, the one subarea is maintained touchable, if not, the certain subarea is maintained untouchable.

### CROSS-REFERENCE TO RELATED APPLICATIONS

This application claims priority to Chinese Patent Application No. 201310447335.3, filed on Sep. 27, 2013, the disclosure of which is incorporated herein by reference.

### FIELD

The present disclosure relates to a method for preventing a false activation of a touch pad, especially a touch pad of a large size used in portable computers.

### BACKGROUND

Advances in technology have enabled the size of personal computers to decrease. As a result, the use of portable computers, such as notebook computers, laptop computers, and notepad computers, is rapidly increasing. A typical notebook computer comprises a display assembly and a base assembly with a keyboard and a touch pad. The touch pad is used for navigating a cursor control. The touch pad has a relative small size and is centered disposed below the keyboard to avoid causing unwanted or false activations of the touch pad.

However, functions of the touch pad of the notebook computer gradually expand to handwriting, drawing, and gesture control. These needs result in the size of the touch pad becoming larger. However, the large sized touch pad has some disadvantages. For example, user's palm may falsely trigger the touch pad when typing on the keyboard, resulting in typing interference.

Therefore, there is need to provide methods for preventing false activation of a touch pad.

### BRIEF DESCRIPTION OF THE DRAWINGS

Implementations of the present technology will now be described, by way of example only, with reference to the attached figures.

FIG. 1 is a flowchart of an embodiment of a method for preventing a false activation of a touch pad.

FIG. 2 is a structural isometric view of an embodiment of a notebook computer with a large-sized touch pad.

FIG. 3 is a diagrammatic view of an embodiment of one way of dividing a touch area on the touch pad.

FIG. 4 is a diagrammatic view of another embodiment of one way of dividing the touch area on the touch pad.

FIG. 5 is a diagrammatic view of a third embodiment one way of dividing the touch area on the touch pad.

FIG. 6 is a flowchart of an embodiment of a way to activate an untouchable subarea of the touch pad to be a touchable area.

FIG. 7 is a flowchart of another embodiment of a way to activate an untouchable subarea to be a touchable area.

FIG. 8 is a flowchart of a third embodiment of a way to activate an untouchable subarea to be a touchable area.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “untouchable” means that all touch functions can not be used by a user even if the user touches a touch pad. The term “substantially” is defined to be essentially conforming to the particular dimension, shape, or other description that is described, such that the component need not be exactly conforming to the description. The term “comprising,” when utilized, means “including, but not necessarily limited to”; it specifically indicates open-ended inclusion or membership in the so-described combination, group, series, and the like.

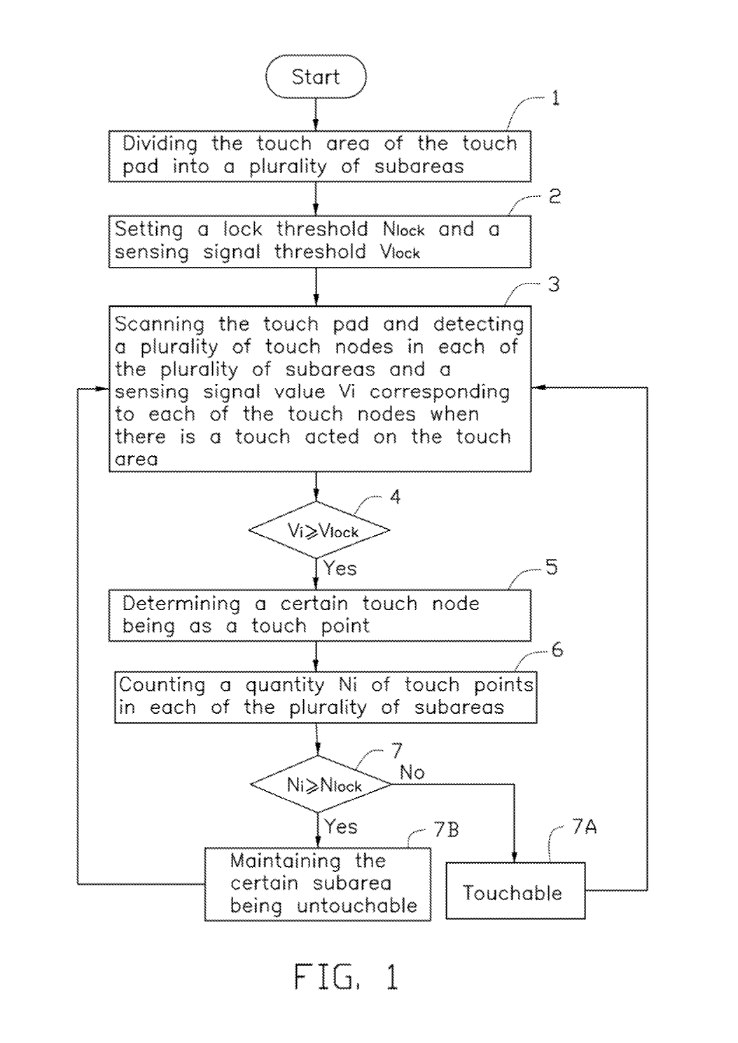

Referring to FIG. 1, one embodiment of a method for preventing a false activation of a touch pad is provided. The touch pad defines a touch area and the method comprises the following steps:

block 1, dividing the touch area of the touch pad into a plurality of subareas;

block 2, setting a lock threshold N_{lock} and a sensing signal threshold V_{lock};

block 3, scanning the touch pad and detecting a plurality of touch nodes in each of the plurality of subareas and a sensing signal value Vᵢ corresponding to each of the touch nodes when there is a touch acted on the touch area;

block 4, determining if the sensing signal value Vᵢ corresponding to each of the plurality of touch nodes is larger than or equals to the sensing signal threshold V_{lock},

block 5, determining a certain touch node being as a touch point when the sensing signal value Vᵢ corresponding to the certain node is larger than or equals to the sensing signal threshold V_{lock};

block 6, counting a quantity Nᵢ of touch points in each of the plurality of subareas;

block 7, determining if the quantity Nᵢ of the touch points in each of the plurality of subareas is less than the lock threshold N_{lock};

block 7A, maintaining a certain subarea being touchable when the quantity Nᵢ of the touch points in the certain subarea is less than the lock threshold N_{lock}; and

block 7B, maintaining the certain subarea being untouchable when the quantity Nᵢ of the touch points in the certain subarea is larger than or equals to the lock threshold N_{lock}.

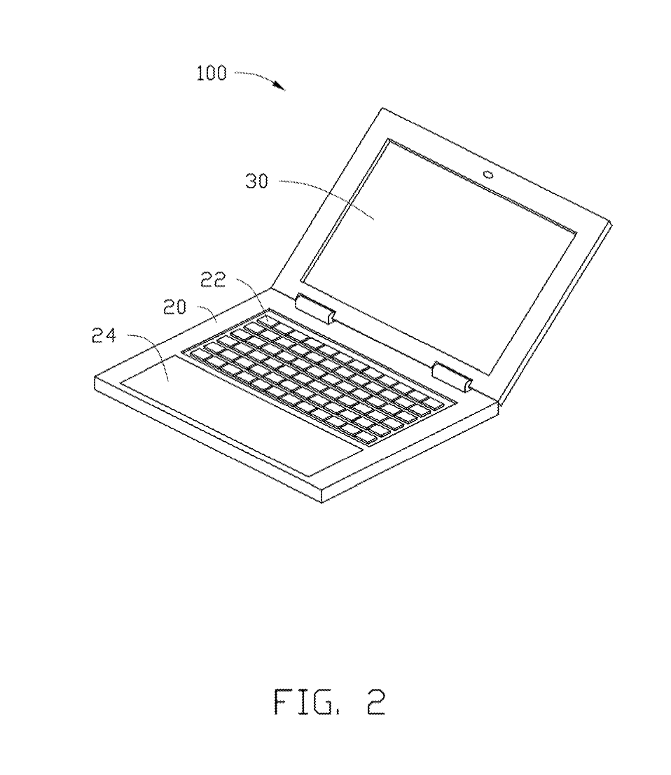

At block 1, the touch pad can be but not limited to, a capacitive touch pad or a resistive touch pad. In addition, the touch pad can be used alone or integrated with a portable computer, such as a notebook computer. Referring to FIG. 2, in at least one embodiment, the touch pad is integrated to a notebook computer 100. The notebook computer 100 can comprise a base assembly 20 and a display 30 connected with the base assembly 20. The base assembly 20 comprises a keyboard 22 and a touch pad 24. The touch pad 24 can be disposed below the keyboard 22. The touch pad 24 can be a large-sized touch pad having a substantially same length with the keyboard 22. The keyboard 22 and the touch pad 24 can cover an entire surface of the base assembly 20. The touch pad 24 with the large size can accomplish various touch operations, such as but not limited to, cursor controlling, gesture controlling, handwriting, and/or painting.

At block 1, the touch area can cover an entire surface of the touch pad 24. A quantity and sizes of the plurality of subareas can be set according to a required detecting precision of the false activation. In at least one embodiment, the size of each of the plurality of subareas can be set based upon a palm width of a user, thereby, a false activation area of the touch pad 24 caused by a palm rest can be precisely defined. In at least one embodiment, a width of each of the plurality of subareas is substantially equal to the palm width.

The plurality of subareas cooperatively covers the entire touch area. The plurality of subareas can be divided by various ways. In at least one embodiment, the touch area is divided into six subareas (A, B, C, D, E, and F) just for a better illustration.

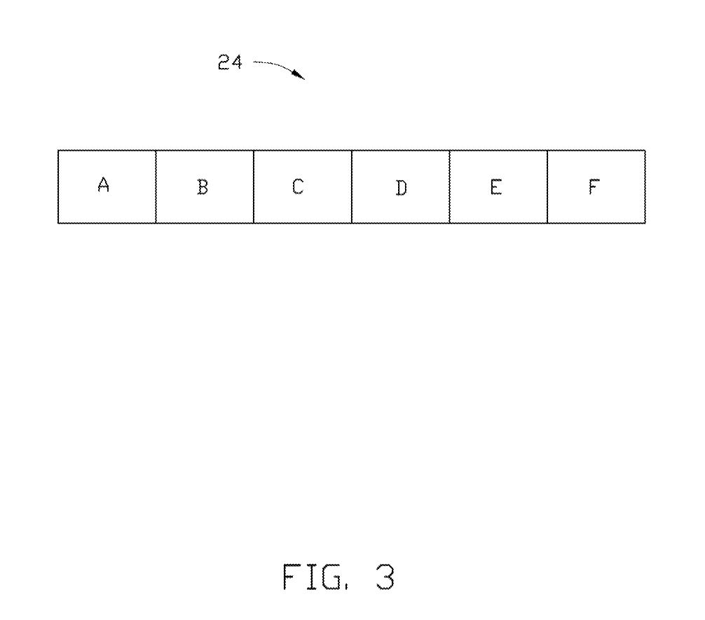

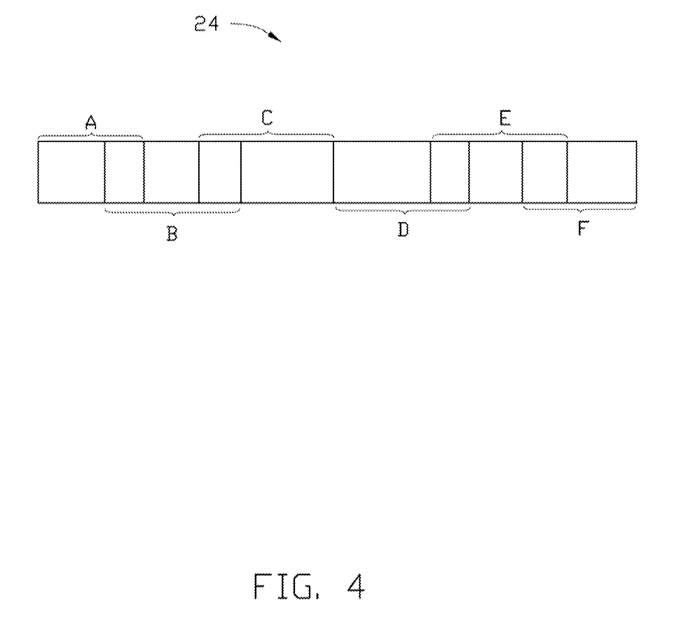

Referring to FIG. 3, in at least one embodiment, the plurality of subareas can be adjoined in sequence and are arranged not to overlap with each other. Referring to FIG. 4, in at least one embodiment, at least two adjacent subareas of the plurality of subareas partially overlap with each other. The palm of the user may rest on a boundary of two adjacent subareas, therefore, a detection precision for the false activation of the touch pad 24 can be increased by setting the partially overlapped subareas. In at least one embodiment, the partially overlapped subareas can be easy false activation areas of the touch pad 24 where the false activation often occurs. The plurality of subareas can comprise central subareas and side subareas. In at least one embodiment, the side subareas are the easy false activation areas. Two adjacent subareas of the side subareas can partially overlap with each other. In addition, the central subareas can only adjoin and are arranged not to overlap with each other. Referring to FIG. 4, the side subareas A, B, and C adjoin and partially overlap with each other, the side subareas D, E, and F adjoin and partially overlap with each other, and the subareas C and D only adjoin but do not overlap with each other for the central subareas are not the easy false activation areas.

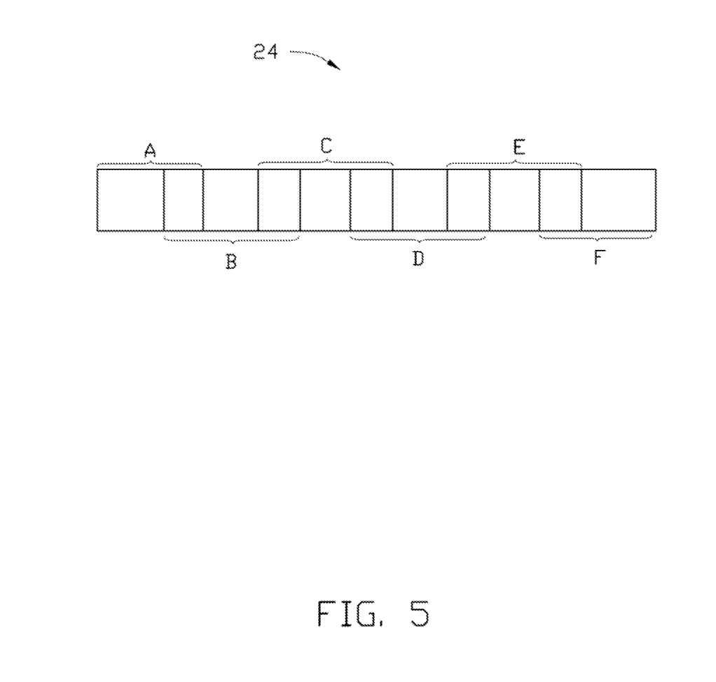

Referring to FIG. 5, in at least one embodiment, every two adjacent subareas can partially overlap with each other to ensure the false activation of the touch pad 24 being located in at least one of the plurality of subareas. Whereby the false activation of the touch pad 24 can be easily and precisely detected.

At block 2, the lock threshold N_{lock} is a number or a numerical range and can be used to measure whether a touching area is the false activation area or not. The lock threshold N_{lock} can be set using a settled quantity of the touch points. If the quantity of the touch points is larger than or equals to the lock threshold N_{lock}, it indicates that there is a large area touch on the touch pad 24 and the large area touch may be a false touch. The lock threshold N_{lock} can be set according to or substantially equals to the quantity of the touch points detected when the palm of the user touches the touch pad 24. In at least one embodiment, the lock threshold N_{lock} equals to 20.

The sensing signal threshold V_{lock} also can be used to measure whether the certain touch node is the touch point or not.

If the sensing signal value Vᵢ is smaller than the sensing signal threshold V_{lock}, there is no touch being considered as acting on a corresponding location of the touch pad 24. Otherwise, the touch (or touch point) is detected on the touch pad 24. In the method, a preventing of the false activation is processed before the output of the touch point. Therefore, the false activation of the touch pad 24 can be effectively avoided.

At blocks 3-5, the each of the touch nodes can be considered as a point or a unit formed by an X coordinate crossed with a Y coordinate. It would cause the sensing signal values V, as long as there is the touch acted on the touch area. But only the sensing signal values V, corresponding to the touch points can activate a touch function. The touch points are some of the touch nodes and can activate the touch function of the touch pad 24. The touch function of the touch pad 24 can not be activated when the sensing signal value Vᵢ is less than the sensing signal threshold V_{lock}.

The block 7 is to determine which subareas are false activation areas and which are not. If one or some of the subareas are not the false activation area, these subareas are maintained touchable. The term touchable means that the user can use touch functions in these subareas and the touch pad 24 will response the touch functions in these subareas.

At block 7B, the term “untouchable” means that the touch pad 24 in the untouchable subarea is locked and no touch functions will be responded even when there is a touch acted on the untouchable subarea.

The method can further comprise a step of monitoring each of the plurality of subareas by blocks 3-7 to dynamically convert the subareas to be touchable or untouchable.

In the method, if the plurality of subareas partially overlap with each other, the false activation may be located in an overlapping region of two adjacent subareas. In this situation, the two adjacent subareas are lock to be untouchable to avoid the false activation of the touch pad 24.

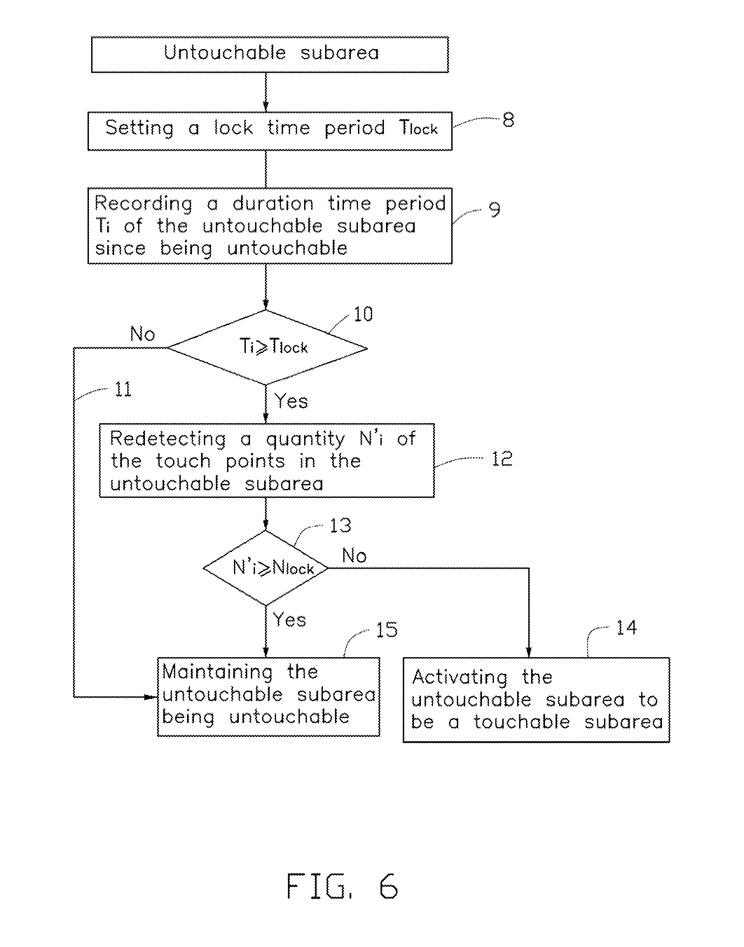

Referring to FIG. 6, the method can further comprise a step of activating the untouchable subarea to a touchable subarea. In at least one embodiment, the activating step can comprise the following substeps:

block 8, setting a lock time period T_{lock};

block 9, recording a duration time period Tᵢ of the untouchable subarea since being untouchable;

block 10, determining if the duration time period Tᵢ exceeds the lock time period T_{lock};

block 11, continuously maintaining the untouchable subarea being untouchable when the duration time period Tᵢ does not exceed the lock time period T_{lock};

block 12, redetecting a quantity N′ᵢ of the touch points in the untouchable subarea when the duration time period Tᵢ exceeds the lock time period T_{lock};

block 13, further determining if N′ᵢ≧N_{lock};

block 14, activating the untouchable subarea to be a touchable subarea when N′ᵢ<N_{lock}; and

block 15, continuously maintaining the untouchable subarea being untouchable when N′ᵢ≧N_{lock}.

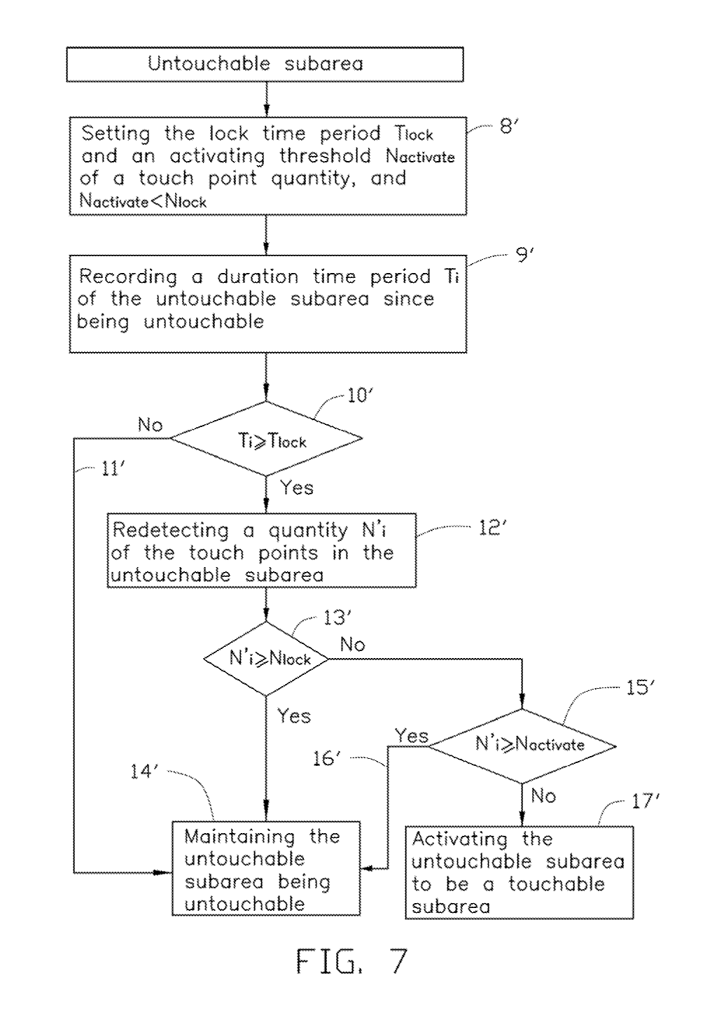

Referring to FIG. 7, in another embodiment, the untouchable subarea can be activated to the touchable subarea by the following substeps:

block 8′, setting the lock time period T_{lock} and an activating threshold N_{activate} of a touch point quantity, and N_{activate}<N_{lock};

block 9′, recording the duration time period Tᵢ of the untouchable subarea since being untouchable;

block 10′, determining if the duration time period Tᵢ exceeding the lock time period T_{lock};

block 11′, continuously maintaining the untouchable subarea being untouchable when the duration time period Tᵢ does not exceed the lock time period T_{lock};

block 12′, redetecting a quantity N′ᵢ of the touch points in the untouchable subarea when the duration time period Tᵢ exceeds the lock time period T_{lock};

block 13′, further determining if N′_{I} is larger than or equals to N_{lock};

block 14′, continuously maintaining the untouchable subarea being untouchable when N′ᵢ≧N_{lock};

block 15′, further determining if N′ᵢ is less than N_{activate} when N′_{I} is less than N_{lock};

block 16′, maintaining untouchable subarea being untouchable when N′ᵢ≧N_{activate}; and

block 17′, activating the untouchable subarea to be the touchable subarea when N′ᵢ<N_{activate}.

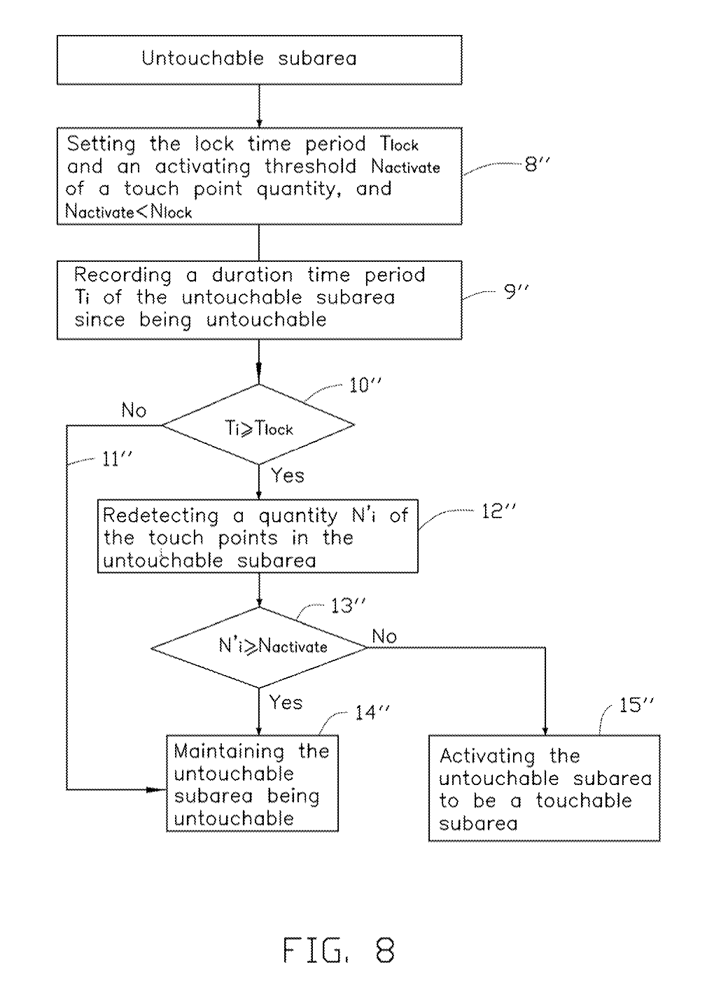

Referring to FIG. 8, in a third embodiment, the untouchable subarea can be activated to the touchable subarea by the following substeps:

block 8″, setting the lock time period T_{lock} and an activating threshold N_{activate} of a touch point quantity, and N_{activate}<N_{lock};

block 9″, recording the duration time period Tᵢ of the untouchable subarea since being untouchable;

block 10″, determining if the duration time period Tᵢ exceeds the lock time period T_{lock};

block 11″, continuously maintaining the untouchable subarea being untouchable when the duration time period Tᵢ does not exceed the lock time period T_{lock};

block 12″, redetecting a quantity N′ᵢ of the touch points in the untouchable subarea when the duration time period Tᵢ exceeds the lock time period T_{lock};

block 13″, further determining if N′ᵢ is less than N_{activate};

block 14″, maintaining untouchable subarea being untouchable when N′ᵢ≧N_{activate}; and

block 15″, activating the untouchable subarea to be the touchable subarea when N′ᵢ<N_{activate}.

The user's palm rested on the touch pad 24 may slightly move when typing on the keyboard. This kind of palm rest is still considered as the false activation of the touch pad 24. The set lock time period T_{lock} can reduce a scanning frequency for determine the untouchable subarea to be touchable or untouchable. In addition, the set lock time period T_{lock} can avoid a false determination, such as falsely activates the untouchable subarea to be the touchable subarea, caused from variations of the sensing signal and the quantity of the touch points in the untouchable subarea at a short time. The lock time period T_{lock} is a time value in a range from about 0.5 seconds to about 1 second.

Similarly, the set activating threshold N_{activate} of the touch point quantity still can reduce the false determination. A ratio of N_{activate} to N_{lock} can be set as: N_{activate}:N_{lock}=0.6:1 to 0.9:1. In at least one embodiment, the ratio is in a range from about 0.8:1 to about 0.9:1 (N_{activate}:N_{lock}).

On one hand, the method disclosed above can effectively avoid the false activation by the palm rest. On the other hand, the method can maintain a correct response for a multi-touch acted on the touch pad at the same time. The method is especially suitable for portable touch device with a large-sized touch pad, such as notebook computers, Smartphone, and tablet.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method for preventing a false activation of a touch pad, the touch pad defining a touch area, the method comprising:
setting a lock threshold N_{lock} and a sensing signal threshold V_{lock};
scanning the touch pad and detecting a plurality of touch nodes in each of a plurality of subareas of the touch pad and a sensing signal value Vᵢ corresponding to each of the touch nodes when there is a touch acted on the touch area;
determining if the sensing signal value Vᵢ corresponding to each of the plurality of touch nodes is larger than or equals to the sensing signal threshold V_{lock},
determining a certain touch node being as a touch point when the sensing signal value Vᵢ corresponding to the certain node is larger than or equals to the sensing signal threshold V_{lock};
counting a quantity Nᵢ of touch points in each of the plurality of subareas;
determining if the quantity Nᵢ of the touch points in each of the plurality of subareas is less than the lock threshold N_{lock};
maintaining a certain subarea being touchable when the quantity Nᵢ of the touch points in the certain subarea is less than the lock threshold N_{lock}; and
maintaining the certain subarea being untouchable when the quantity Nᵢ of the touch points in the certain subarea is larger than or equals to the lock threshold N_{lock}.

2. The method of claim 1, wherein the plurality of subareas cover the entire touch area and at least two adjacent subareas are partially overlapped with each other.

3. The method of claim 1, wherein the plurality of subareas are defined along a length extending direction of the touch pad, the plurality of subareas comprises side subareas and central areas located between the side subareas, the side subareas are partially overlapped and the central areas are not overlapped.

4. The method of claim 1, wherein all adjacent subareas in the plurality of subareas partially overlap with each other.

5. The method of claim 1, wherein the plurality of subareas adjoin in sequence and do not overlap with each other.

6. The method of claim 1, wherein the lock threshold N_{lock} is a number or a numerical range substantially equals to a quantity of the touch points detected when a palm of a user touches the touch pad.

7. The method of claim 6, wherein the lock threshold N_{lock} is the number and equals to 20.

8. The method of claim 1 further comprising a step of monitoring each of the plurality of subareas to dynamically convert the individual subarea touchable or untouchable.

9. The method of claim 1 further comprising a step of activating an untouchable subarea to be a touchable subarea comprising:
setting a lock time period T_{lock};
recording a duration time period Tᵢ of the untouchable subarea since being untouchable;
determining if the duration time period Tᵢ exceeds the lock time period T_{lock};
continuously maintaining the untouchable subarea being untouchable when the duration time period Tᵢ does not exceed the lock time period T_{lock};
redetecting a quantity N′ᵢ of the touch points in the untouchable subarea when the duration time period Tᵢ exceeds the lock time period T_{lock}; and
activating the untouchable subarea to be a touchable subarea when N′ᵢ≦N_{lock}.

10. The method of claim 1 further comprising a step of activating an untouchable subarea to be a touchable subarea comprising:
setting a lock time period T_{lock} and an activating threshold N_{activate} of a touch point quantity, and N_{activate}<N_{lock};
recording a duration time period Tᵢ of the untouchable subarea since being untouchable;
determining if the duration time period Tᵢ exceeding the lock time period T_{lock};
continuously maintaining the untouchable subarea being untouchable when the duration time period Tᵢ does not exceed the lock time period T_{lock};
redetecting a quantity N′ᵢ of the touch points in the untouchable subarea when the duration time period Tᵢ exceeds the lock time period T_{lock};
further determining if N′_{I} is larger than or equals to N_{lock};
continuously maintaining the untouchable subarea being untouchable when N′ᵢ≧N_{lock};
further determining if N′ᵢ is less than N_{activate};
maintaining untouchable subarea being untouchable when N′ᵢ≧N_{activate}; and
activating the untouchable subarea to be the touchable subarea when N′ᵢ<N_{activate}.

11. The method of claim 1 further comprising a step of activating an untouchable subarea to a touchable subarea comprising:
setting a lock time period T_{lock} and an activating threshold N_{activate} of a touch point quantity, and N_{activate}<N_{lock};
recording a duration time period Tᵢ of the untouchable subarea since being untouchable;
determining if the duration time period Tᵢ exceeds the lock time period T_{lock};
continuously maintaining the untouchable subarea being untouchable when the duration time period Tᵢ does not exceed the lock time period T_{lock};
redetecting a quantity N′ᵢ of the touch points in the untouchable subarea when the duration time period Tᵢ exceeds the lock time period T_{lock};
further determining if N′ᵢ is less than N_{activate};
maintaining untouchable subarea being untouchable when N′ᵢ≧N_{activate}; and
activating the untouchable subarea to be the touchable subarea when N′ᵢ<N_{activate}.

12. The method of claim 9, wherein the lock time period T_{lock} is a time value in a range from about 0.5 seconds to about 1 second.

13. The method of claim 10, wherein the lock time period T_{lock} is a time value in a range from about 0.5 seconds to about 1 second.

14. The method of claim 11, wherein the lock time period T_{lock} is a time value in a range from about 0.5 seconds to about 1 second.

15. The method of claim 10, wherein a ratio of N_{activate} to N_{lock} is set as: N_{activate}:N_{lock}=0.6:1 to 0.9:1.

16. The method of claim 11, wherein a ratio of N_{activate} to N_{lock} is set as: N_{activate}:N_{lock}=0.6:1 to 0.9:1.
